(19) United States
(12) Patent Application Publication
(10) Pub. No.: US 2013/0173109 A1
(43) Pub. Date: Jul. 4, 2013

(54) VEHICLE MODEL CALIBRATION SYSTEM FOR A MOBILE MACHINE

(71) Applicants: Ramadev Burigsay Hukkeri, Pittsburgh, PA (US); Michael Allen Taylor, Swissvale, PA (US)

(72) Inventors: Ramadev Burigsay Hukkeri, Pittsburgh, PA (US); Michael Allen Taylor, Swissvale, PA (US)

(21) Appl. No.: 13/338,859

(22) Filed: Dec. 28, 2011

(51) Int. Cl. G05D 1/00

(52) U.S. Cl. 701/23

(57) ABSTRACT

A method is disclosed for recalibrating a vehicle model used to autonomously control a machine on a worksite, with a calibration system including at least one processor. In the method at least one recalibration condition is determined for which recalibration of the vehicle model is to occur. Time information, location information, and testing condition information are determined for the at least one recalibration condition. The time information includes a determination of a time when recalibration is to be performed. The location information includes a determination of a location suitable for performing the recalibration. The testing condition information includes a determination of a testing condition to be used during the recalibration.

### TECHNICAL FIELD

The present disclosure relates generally to a mobile machine and, more particularly, to a vehicle model calibration system for a mobile machine.

### BACKGROUND

Autonomous worksites are designed to provide productivity gains through more consistency in processes. An autonomous worksite may have a plurality of autonomous machines such as, for example, off-highway haul trucks, motor graders, and other types of heavy equipment that are used to perform a variety of tasks. The operation of the machines is usually controlled by computers, processors, and other electronic controllers rather than human operators. As a result, autonomous operation may minimize the environmental impact on the worksite, enhance the productivity of the machines, and reduce the human resources required for controlling the operation of the worksite.

To help guide the autonomous machines safely and efficiently on the worksite, the machines are usually equipped with sensors for detecting objects on the worksite. For example, RADAR sensors, SONAR sensors, LIDAR sensors, IR and non-IR cameras, and other similar sensors may be used. The sensed objects may include specific areas on the worksite (e.g., areas at which material is loaded and unloaded), the other machines on the worksite, and any obstructions on the worksite. The machines are also generally equipped with sensors for detecting information regarding characteristics of the machine itself (e.g., speed, steering angle, orientation such as pitch and roll, geographical location, load weight, and load distribution). A vehicle model, which is a computer model that is used in autonomous operation of the machine on the worksite, is stored in a computer memory of the machine. Processors on-board the machine receive the outputs from the sensors and, using the vehicle model, predict whether the machine may continue to operate safely and efficiently given its current speed and steering angle, and/or future drive commands of the machine, for example. In the event the processors predict that the machine should not continue on its current course (e.g., the processors predict the machine will collide with a sensed object if the machine maintains its current steering angle), the processors also use the vehicle model to determine what changes should be made, and to predict whether these changes will in fact result in continued safe and efficient operation of the machine.

During manufacture of the autonomous machine, an uncalibrated vehicle model is initially stored in the computer memory. An initial calibration of the vehicle model is necessary for safe and efficient operation of the machine, since the predicted performance of the autonomous machine may vary substantially from the actual performance of the machine. To perform the initial calibration of the vehicle model, the autonomous machine is shipped to a specialized testing facility, where the machine undergoes a series of specific tests. The tests measure the actual performance of the machine, using the uncalibrated vehicle model, under a variety of conditions, including different loads, speeds, steering angles, and orientations of the machine. After the conclusion of the testing, the actual performance of the machine under the various conditions is compared to the performance that was predicted by the uncalibrated vehicle model under those same conditions. The vehicle model is adjusted or calibrated based on the comparison, so that future use of the calibrated vehicle model will result in the actual operation of the autonomous machine being substantially the same as the predicted operation of the machine.

Subsequently, the calibration system may be required to recalibrate the vehicle model, either because of a change in the configuration of the machine, or because of wear of components used in the machine. Recalibration may occur in a manner similar to initial calibration of the vehicle model.

Although these processes may provide accurate calibration and recalibration of the vehicle model, the processes suffer from numerous disadvantages. For example, after fabrication, the complete machine must be shipped to the specialized testing facility to perform the initial calibration of the vehicle model. The testing facility may be a significant distance from the autonomous worksite. The size of the testing facility may limit the number of machines undergoing vehicle model calibration at any particular time. Further, it may take a number of weeks or months to complete all of the specific tests required for complete calibration of the vehicle model. Thus, the autonomous vehicle may not be available to perform any task on the autonomous worksite for a relatively long period of time, until the vehicle model is completely calibrated and the machine is shipped to the autonomous worksite. Subsequent recalibration of the vehicle model may result in similar disadvantages, since it may be necessary to ship the autonomous machine back to the specialized testing facility to again undergo the series of specific tests.

The disclosed vehicle model calibration system is directed to overcoming one or more of the problems set forth above and/or other problems of the prior art.

### SUMMARY

The disclosure may provide a method of recalibrating a vehicle model used to autonomously control a machine on a worksite, with a calibration system that may include at least one processor. At least one recalibration condition may be determined for which recalibration of the vehicle model is to occur. Time information, location information, and testing condition information may be determined for the at least one recalibration condition. The time information may include a determination of a time when recalibration may be performed. The location information may include a determination of a location that may be suitable for performing the recalibration. The testing condition information may include a determination of a testing condition that may be used during the recalibration.

The disclosure may further provide a method of calibrating a vehicle model used to autonomously control a machine on a worksite, with a calibration system that may include at least one processor. An initial calibration of the vehicle model may be performed by autonomously controlling a machine, based on the vehicle model, to perform an operation at a worksite. During performance of the operation, at least one condition may be determined for which the vehicle model may be calibrated. Machine performance of the operation may be determined during the at least one condition. The vehicle model may be adjusted based on the determined machine performance. The vehicle model may be recalibrated subsequent to the initial calibration. At least one recalibration condition may be determined for which recalibration of the vehicle model may occur. Time information, location information, and testing condition information may be determined for the at least one recalibration condition. The time information may include a determination of a time when recalibration may be performed. The location information may include a determination of a location that may be suitable for performing the recalibration. The testing condition information may include a determination of a testing condition that may be used during the recalibration. The initially-calibrated vehicle model may be adjusted for the recalibration condition based on the time information, the location information, and the testing condition information

### BRIEF DESCRIPTION OF THE DRAWINGS

FIG. 1 is a side view pictorial illustration of a machine having an exemplary disclosed vehicle model calibration system;

FIG. 2 is a diagrammatic illustration of an exemplary disclosed initial calibration operation performed by the vehicle model calibration system of FIG. 1; and

FIG. 3 is a diagrammatic illustration of an exemplary disclosed recalibration operation performed by the vehicle model calibration system of FIG. 1.

### DETAILED DESCRIPTION

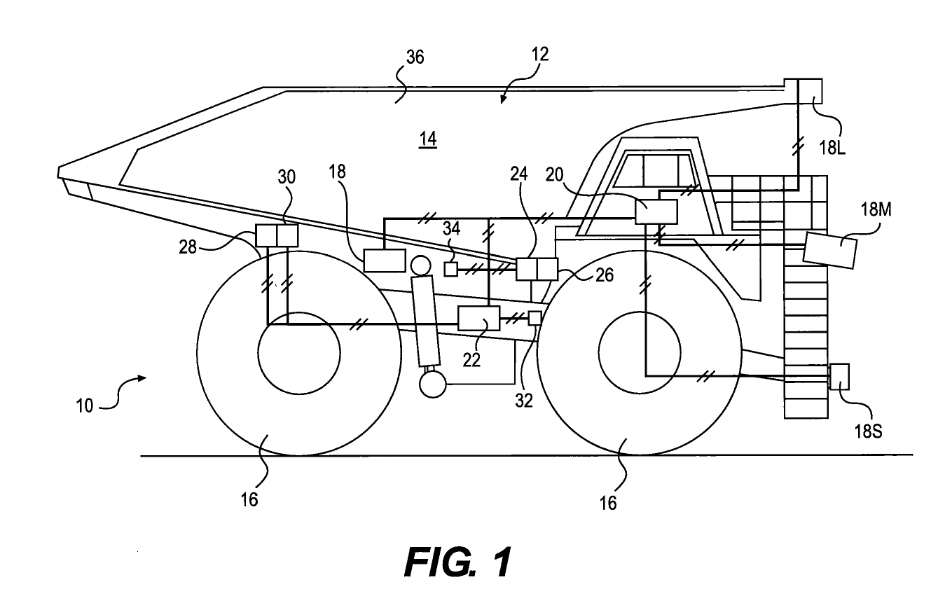

FIG. 1 illustrates a machine 10 having an exemplary vehicle model calibration system 12 that may provide an initial calibration as well as recalibrate a vehicle model used to autonomously control machine 10 on a worksite, such as an autonomous worksite. Machine 10 may embody an autonomous mobile machine, for example an earth moving machine such as an off-highway haul truck, a wheel loader, a motor grader, or any other mobile machine known in the art, which may be controlled on the autonomous worksite by computers, processors, and other electronic controllers rather than human operators. Machine 10 may include, among other things, a body 14 supported by one or more traction devices 16, and one or more sensors 18 mounted to body 14 and used for object detection. The objects detected by sensors 18 may include specific areas on the autonomous worksite (e.g., areas at which material is loaded and unloaded), other autonomous or human-operator-controlled machines on the worksite, and any obstructions on the worksite.

In one embodiment, machine 10 may be equipped with short range sensors 18S, medium range sensors 18M, and long range sensors 18L located at different positions around body 14 of machine 10. Each sensor 18 may embody a device that detects and ranges objects, for example a LIDAR (light detection and ranging) device, a RADAR (radio detection and ranging) device, a SONAR (sound navigation and ranging) device, an IR (infra-red) or non-IR (non-infrared) camera device, or another device known in the art. In one example, sensor 18 may include an emitter that emits a detection beam and an associated receiver that receives a reflection of that detection beam. Based on characteristics of the reflected beam, a distance and a direction from an actual sensing location of sensor 18 on machine 10 to a portion of the sensed object may be determined. Sensor 18 may then generate a position signal corresponding to the distance and direction, and communicate the position signal to a controller 20. Controller 20 may receive the position signal from sensor 18 and, using the calibrated vehicle model, may operate machine 10 so as to avoid a collision with the sensed object. For example, controller 20 may steer machine 10 to the left or right to avoid the object, and/or may slow down or speed up machine 10 if the object is moving and a change in speed of machine 10 may avoid collision.

Machine 10 may also be equipped with one or more sensors 22, mounted at different locations on machine 10, for detecting information regarding one or more conditions of the machine itself, such as a load carried by the machine, a state of the machine, and/or a location of the machine. In one embodiment, sensors 22 may include a speed sensor 24, a steering angle sensor 26, a load weight sensor 28, a load distribution sensor 30, an orientation sensor 32, and a location and heading sensor 34.

Speed sensor 24 may detect an actual speed of machine 10 on the autonomous worksite. The speed of machine 10 may be detected in a variety of ways. For example, speed sensor 24 may detect a number of revolutions over a given time period for a component of one traction device 16, such as a wheel hub, and either speed sensor 24, controller 20, or another processor may determine the speed of machine 10 using this information. In another embodiment, speed sensor 24 may measure an actual distance traveled by machine 10 over a given time period, and either speed sensor 24, controller 20, or another processor may determine the speed of machine 10. Speed sensor 24 is not limited to a specific location on machine 10, however, and is not limited in the way that it detects the speed of machine 10.

Steering angle sensor 26 may detect an actual steering angle of machine 10. The steering angle may be detected in a variety of ways. For example, steering angle sensor 26 may sense a location, angle, and/or other characteristic of a component of one traction device 16, such as a wheel hub. In another embodiment, steering angle sensor 26 may sense a location, angle, and/or other characteristic of another component of machine 10, such as a rack and/or a pinion when machine 10 is turned by a rack-and-pinion steering system. In that case, a rotation angle of the pinion and/or a translation of the rack may be sensed, and either steering angle sensor 26, controller 20, or another processor may determine the steering angle of machine 10 using this information. Steering angle sensor 26 is not limited to a specific location on machine 10, however, and is not limited in the way that it detects the steering angle of machine 10.

Load weight sensor 28 may detect an actual weight of material being hauled by machine 10, in the event machine 10 is configured to haul material on the autonomous worksite. The weight of the load carried by machine 10 may be detected in a variety of ways. For example, load weight sensor 28 may measure decreases in effective lengths of one or more springs supporting a dump box 36 of machine 10, and either load weight sensor 28, controller 20, or another processor may determine the weight of material hauled by machine 10 using this information. Load weight sensor 28 is not limited to a specific location on machine 10, however, and is not limited in the way that it detects the weight of material being hauled by machine 10.

Load distribution sensor 30 may detect an actual distribution of the weight of the material being hauled by machine 10. The distribution of the weight hauled by machine 10 may be detected in a variety of ways. For example, load distribution sensor 30 may measures decreases in effective lengths between or among groups of springs supporting dump box 36 of machine 10, and by comparing lengths of springs on the front of dump box 36 to lengths of springs on the back of dump box 36 and/or to lengths of springs on the left or right side of dump box 36. Either load distribution sensor 30, controller 20, or another processor may determine the distribution of the weight of the material hauled by machine 10. Load distribution sensor 30 is not limited to a specific location on machine 10, however, and is not limited in the way that it detects the distribution of weight of material being hauled by machine 10.

Orientation sensor 32 may determine an actual orientation of machine 10 on the autonomous worksite. The orientation of machine 10 may include a roll of machine 10, which may be an angle measured about a roll axis that extends generally between a front and a back of machine 10, and/or may include a pitch of machine 10, which may be an angle measured about a pitch axis that extends generally between left and right sides of machine 10. Orientation sensor may directly detect the orientation of machine 10 (e.g., detect the orientation of machine 10 relative to an artificial horizon), or detect the orientation of an area on the ground that supports machine 10. Either orientation sensor 32, controller 20, or another processor may determine the orientation of machine 10 using this information. Orientation sensor 32 is not limited to a specific location on machine 10, however, and is not limited in the way that it detects the orientation of machine 10.

Location and heading sensor 34 may determine an actual geographical location and/or an actual heading of machine 10 on the autonomous worksite. The location and heading of machine 10 may be detected in a variety of ways. For example, sensor 34 may include a global position detecting system to determine the geographical location of machine 10. In another embodiment, sensor 34 may include a local position detecting system that indicates the geographical location and/or heading of machine 10 relative to one or more transmitters on the autonomous worksite. Either sensor 34, controller 20, or another processor may determine the location of machine 10 and/or the actual heading of machine 10 based on this information. Sensor 34 is not limited to a specific location on machine 10, however, and is not limited in the way that it detects the location of machine 10.

The above-described sensors 22 may generate signals corresponding to the detected condition of machine 10, and communicate the signals to controller 20. Controller 20 may receive the signals from sensors 22 and, using the calibrated vehicle model, may operate machine 10 to maintain safe and efficient operation of machine 10 on the autonomous worksite. For example, controller 20 may slow machine 10 and/or decrease the steering angle of machine 10 if it appears that rollover of machine 10 may be imminent.

Controller 20 may include means for monitoring, recording, conditioning, storing, indexing, processing, and/or communicating information received from sensors 18 and sensors 22. These means may include, for example, a memory, one or more data storage devices, one or more processors or central processing units, or any other components, including tangible, physical, and non-transitory components, which may be used to run the disclosed application. Furthermore, although aspects of the present disclosure may be described generally as being stored within a computer memory, one skilled in the art will appreciate that these aspects can be stored on or read from different types of computer program products or non-transitory and tangible computer-readable media such as computer chips and secondary storage devices, including hard disks, floppy disks, optical media, CD-ROM, or other forms of RAM or ROM. Controller 20 may communicate with, receive information and/or instructions from, or otherwise by controlled by an automated worksite management system, such as Caterpillar Inc.'s MINESTAR SYSTEM™. The worksite management system may include means for monitoring, recording, conditioning, storing, indexing, processing, and/or communicating information received from sensors 18, sensors 22, and/or controller 20. These means may include, for example, a memory, one or more data storage devices, one or more processors or central processing units, or any other components, including tangible, physical, and non-transitory components, which may be used to run the disclosed application.

Initially, the vehicle model stored in a computer memory accessible by controller 20 of machine 10 may be uncalibrated. As stated above when machine 10 operates on the autonomous worksite, machine 10 may use the vehicle model to predict whether, in view of signals received from sensors 18 and 22, machine 10 may continue to operate safely and efficiently, or whether changes in the operation of machine 10 should be made. Thus, if use of the uncalibrated model results in differences between the predicted operation of machine 10 and the actual operation of machine 10, it may be advisable to calibrate the vehicle model so that the predicted and actual operations are substantially similar to one another.

During calibration of the vehicle model, one or more conditions of machine 10 may be varied, while one or more of the other conditions of machine 10 may be maintained as substantially constant. For example, machine 10 may be loaded to a certain weight, with a certain load distribution. Machine 10 may proceed relatively straight (i.e., at a steering angle of about 0 degrees), on a relatively flat surface (i.e., such that the roll and pitch of the machine are each about 0 degrees). For a speed of 5 miles per hour, the actual distance necessary to stop machine 10 may be determined. The actual stopping distance may also be determined for speeds greater than 5 miles per hour (e.g., 7 miles per hour, 10 miles per hour, etc.), as well as for speeds less than 5 miles per hour (3 miles per hour, 1 mile per hour, etc.). These actual determinations may be made by one or more of sensors 22, alone or in conjunction with controller 20 (e.g., location and heading sensor 34 may be used to determine stopping distance for each of the speeds).

Thereafter, another condition of machine 10 may be varied. For example, the weight loaded in machine 10 may be increased or decreased, the distribution of the weight may be varied, the steering angle of machine 10 may be varied, or the surface on which machine 10 is tested may be varied. For each of the variations, an actual performance of machine 10 may be determined. Thus, actual performance of machine 10 may be determined under a variety of conditions, such as loads, operating states, orientations, and/or positions, which machine 10 may be expected to experience on the autonomous worksite.

To calibrate the vehicle model, the actual performance of machine 10 for the variety of conditions may be compared to the corresponding performance predicted by the uncalibrated vehicle model, and the uncalibrated vehicle model may be adjusted based on results of those comparisons. For example, as discussed above machine 10 may be loaded to a certain weight, with a certain load distribution, and proceed relatively straight (i.e., at a steering angle of about 0 degrees) on a relatively flat surface (i.e., such that the roll and pitch of the machine are each about 0 degrees). For each speed at which the actual stopping distance of machine 10 is determined, the uncalibrated vehicle model may be used to predict a stopping distance based on the same load weight and distribution, steering angle, orientation, and the like. Comparisons of the actual and expected stopping distances may be made, such as by controller 20 or another processor. The vehicle model may be adjusted or calibrated based on results of the comparisons, such that the stopping distances predicted by using the vehicle model may be substantially similar to the actual stopping distances. For example, one or more mathematical expressions or equations may be derived to account for differences between expected and actual performances. Similar comparisons may be made for each of the combinations of conditions under which the actual performance of machine 10 is determined, so that the calibrated vehicle model may accurately predict the performance of machine 10 on the autonomous worksite, including conditions for which machine 10 was not directly tested (e.g., a speed of 8 miles per hour). Thus, by this process the uncalibrated vehicle model may undergo a first, initial calibration.

Subsequently, the calibration system may be required to recalibrate the vehicle model, such as because of a change in the configuration of the machine, or because of wear of components used in the machine. As discussed above, the previously-calibrated vehicle model may be stored in the computer memory accessible by controller 20 of machine 10. Machine 10 may use this calibrated vehicle model to predict whether, in view of signals received from sensors 18 and 22, machine 10 may continue to operate safely and efficiently on the autonomous worksite, or whether changes in the operation of machine 10 should be made. Thus, if use of the previously-calibrated model results in differences between the predicted operation of machine 10 and the actual operation of machine 10, it may be advisable to recalibrate the vehicle model so that the predicted and actual operations are substantially similar to one another.

To recalibrate the vehicle model, one or more conditions of machine 10 may be varied, while one or more of the other conditions of machine 10 may be maintained as substantially constant. For each of the variations, an actual performance of machine 10 may be determined. Thus, actual performance of machine 10 may be determined under a variety of conditions that machine 10 may be expected to experience on the autonomous worksite. The actual performance of machine 10 for the variety of conditions may then be compared to the corresponding performance predicted by the previously-calibrated vehicle model. The vehicle model may be adjusted based on results of the comparisons. For example, one or more mathematical expressions or equations may be derived to account for differences between expected and actual performances. Similar comparisons may be made for each of the combinations of conditions under which the actual performance of machine 10 is determined, so that the recalibrated vehicle model may accurately predict the performance of machine 10 on the autonomous worksite, including conditions for which machine 10 was not directly tested.

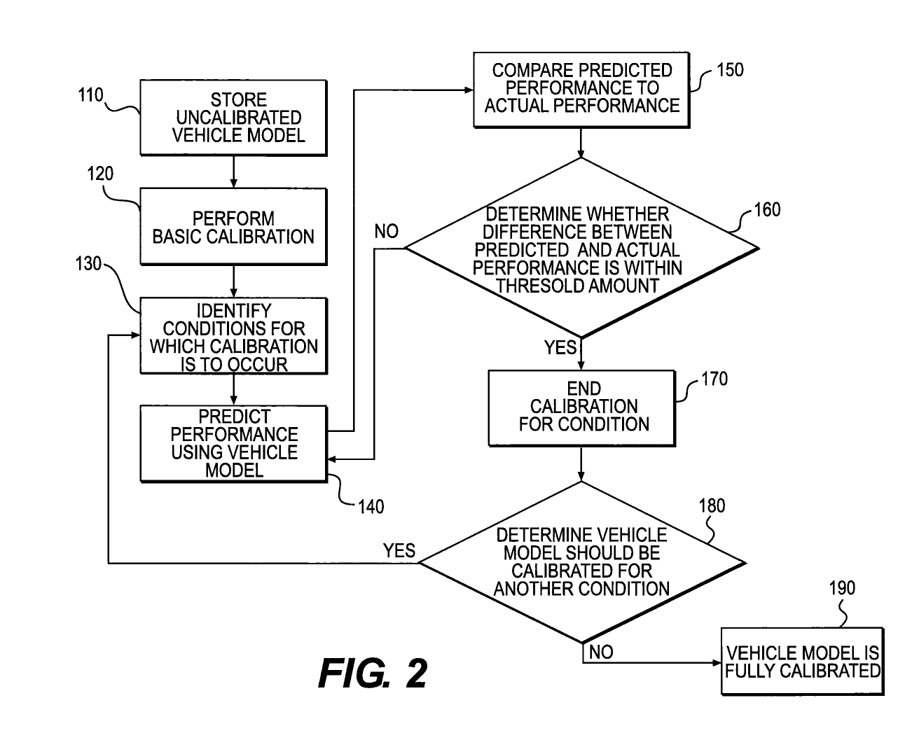

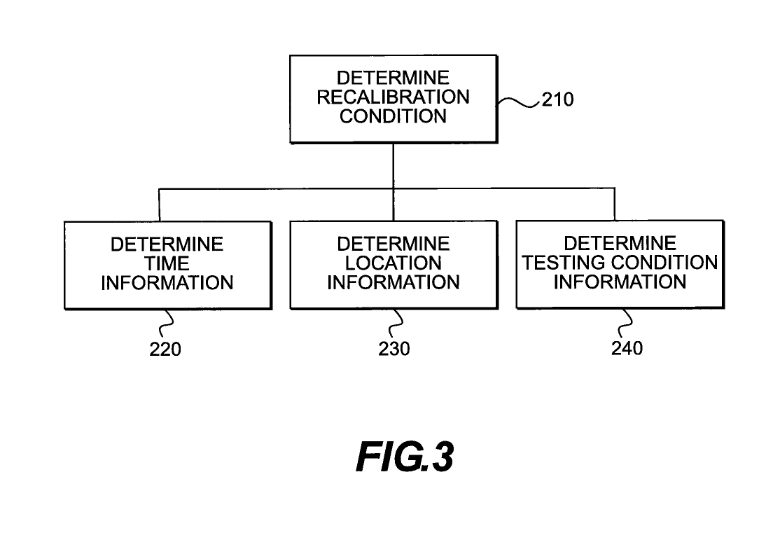

Exemplary operation of the initial vehicle model calibration process that may be performed by the controller 20 is discussed below, with reference to FIG. 2. FIG. 3 illustrates an exemplary operation of the recalibration process for the vehicle model, which may be performed in conjunction with the controller 20.

### INDUSTRIAL APPLICABILITY

The disclosed vehicle model calibration system and process may be applicable to any mobile machine utilizing a vehicle model to control movement of the machine. In exemplary embodiments, the vehicle model used by machine 10 may be initially calibrated and subsequently recalibrated after a period of use so that when the vehicle model is used by controller 20 the predicted performance of machine 10 may be substantially similar to the actual performance of machine 10. The following disclosure provides an exemplary process for initially calibrating the vehicle model, as well as subsequent recalibration of the vehicle model.

As shown in FIG. 2, initially a computer memory accessible by controller 20 of machine 10 may have stored therein an uncalibrated vehicle model (Step 110). The uncalibrated vehicle model may, but need not, be based on a calibrated vehicle model from a similar machine. For example, when machine 10 is an off-highway haul truck, the uncalibrated vehicle model initially stored in the computer memory of machine 10 may be based on one or more calibrated vehicle models from one or more similarly-equipped off-highway haul trucks. Thus, machine 10 may be programmed to include the vehicle model from a similar machine prior to being controlled on an autonomous worksite.

The uncalibrated vehicle model may, but need not, undergo basic calibration at the facility where machine 10 is manufactured (Step 120). For example, the manufacturing facility may include a relatively limited testing facility, which may not be fully equipped to perform complete vehicle model calibration. Thus, calibration of the vehicle model in accordance with this process may avoid the need for the machine to be shipped to the specialized testing facility where the machine may undergo weeks or months of extensive testing to complete all of the specific tests for complete calibration of the vehicle model, as is required by known calibration methods. Instead, machine 10 may be shipped to the autonomous worksite after completion of this basic calibration at the manufacturing facility.

Although the vehicle model used by controller 20 to control machine 10 may be calibrated at the specialized testing facility, or may even be calibrated at a testing facility setup on the autonomous worksite, the vehicle model used by machine 10 may instead be incrementally calibrated during operation of machine 10 on the autonomous worksite, at one or more locations or calibration areas on the worksite. Controller 20 may identify conditions of machine 10, including various loads, operating states, orientations, and/or positions of the machine, for which calibration has not yet been completed and is to occur (Step 130). In some embodiments, calibration of the vehicle model on the autonomous worksite for the identified condition may be accomplished as follows. Controller 20 may control machine 10 in accordance with the vehicle model that has undergone basic calibration in accordance with Steps 110 and 120 described above. Machine 10 may begin driving at a relatively slow speed, for example, and while driving may begin scanning both the autonomous worksite with sensors 18 as well as conditions of machine 10 with sensors 22. Controller 20 may determine whether a portion of the autonomous worksite is suitable (e.g. is a suitable calibration area) for beginning calibration with respect to one or more conditions for which calibration is to occur. For example, machine 10 may use scanners 18 and/or 22, or may be programmed by a human who oversees the autonomous worksite, to locate a relatively flat, level area on the worksite. The flat, level area on the worksite may be a main travel path at the entrance of the worksite or may be a loading or unloading area within the autonomous worksite. Machine 10 may not be able to locate, or may not have been programmed to locate, an area suitable for testing. In these situations, controller 20 may alert the human overseeing the autonomous worksite that a flat, level area is required to begin calibration of the vehicle model. Machine 10 may be programmed, for example, to drive to the calibration area. Once machine 10 is on the flat, level portion of the worksite, machine 10 may use sensors 18 and 22 to provide inputs to controller 20, and may vary one or both of speed and turning angle of machine 10, for example. Depending on the condition for which calibration is to occur, a different area of the worksite may be located, such as a banked and/or graded area on the worksite.

Controller 20 may receive outputs from sensors 18 and 22, and may use the vehicle model that has undergone basic calibration to predict the operation of machine 10 (Step 140). For example, the vehicle model may predict stopping distances for machine 10, how machine 10 may increase or decrease in speed, how machine 10 may steer, and the like, for the various speeds and/or steering angles.

Controller 20 may then compare the previously-predicted operation of machine 10 with a subsequently determined actual operation of machine 10 (Step 150). For example, controller 20 may receive information from sensors 18 and 22 indicating the actual performance of machine 10 at the various speeds and/or steering angles for which predictions were made. In particular, the vehicle model may compare actual stopping distances for machine 10, how machine 10 actually increased and decreased in speed, and how machine 10 actually turned, with the corresponding predictions.

As long as a difference between the predicted and actual operation of machine 10 exceeds a threshold amount (Step 160-NO), the vehicle model may continue to be adjusted, in order to account for the difference between the predicted and actual operation of machine 10. The threshold amount may be an amount the actual performance of machine 10 is permitted to deviate from the predicted performance of machine 10 without requiring updating of the vehicle model. For example, the vehicle model may predict that based on the load weight, speed, orientation, and other conditions for machine 10, the expected stopping distance of machine 10 is 50 feet. The actual stopping distance for machine 10 under these conditions, however, may be 60 feet. When the threshold amount is set, for example, to be a percentage of the predicted amount of 10%, or is set to be a value of 5 feet, the difference between the predicted and actual operation of machine 10 exceeds the threshold amount. Thus, in this example the vehicle model may continue to be adjusted so that subsequent predictions are closer to the actual performance of machine 10. For example, one or more mathematical expressions or equations may be derived to account for the differences between the predicted and actual performances, and the vehicle model may be adjusted in view of these expressions or equations. Controller 20 of machine 10 may again use the vehicle model to predict the operation of machine 10 (Step 140), and compare the predicted operation with the subsequent actual operation of machine 10 (Step 150). Steps 140 and 150 may be repeated until the differences between the predicted and actual operations of machine 10 are within the threshold amount (Step 160—YES), at which time the vehicle model may be considered fully calibrated with respect to the particular conditions tested (Step 170). Steps 140 and 150 may be run consecutively, without machine 10 performing another operation, until the vehicle model is fully calibrated for the particular condition tested. Alternately, steps 140 and 150 may be run so that the vehicle model is partially calibrated with respect to the particular condition tested, and machine 10 may be permitted to perform other operations (e.g., work) on the worksite, and subsequent repeating of steps 140 and 150 may take place at a later time to provide full calibration.

Controller 20 may then determine that the vehicle model should be calibrated with respect to one or more other conditions (Step 180—YES). Controller 20 may repeat Steps 130-170 until the vehicle model is fully calibrated for all conditions that machine 10 may reasonably be expected to encounter on the autonomous worksite. Once this occurs, controller 20 will determine the vehicle model is fully calibrated (Step 190). For example, when the vehicle model used by controller 20 of machine 10 has only been calibrated with respect to the relatively flat, level area on the worksite, when sensors 22 determine that machine 10 is on a sloped area on the autonomous worksite, controller 20 may determine that the vehicle model may now be calibrated with respect to the sloped area. Controller 20 may initially drive machine 10 at a relatively slow speed, and a relatively constant steering angle, until some calibration has occurred with respect to the sloped portion of the autonomous worksite. Machine 10 may then continue to determine what additional tests should be performed to further calibrate the vehicle model with respect to the sloped portion. Similar determinations may occur as the sensors 18 and 22 determine different conditions for which complete calibration has not yet occurred (e.g., different load weights, different weight distributions, different machine orientations, etc.). As stated above, once controller 20 determines that the vehicle model has been calibrated for all conditions that may reasonably be expected to be encountered by machine 10 on the autonomous worksite, controller 20 may determine that the vehicle model is fully calibrated.

Subsequent to the initial calibration, the disclosed calibration system may also permit recalibration of the vehicle model, such as when wear of components on machine 10 is suspected, at regular intervals during the life of machine 10, when a configuration of machine 10 is changed, or after machine 10 has been repaired. An exemplary process for determining a recalibration plan, used in recalibration of the vehicle model, is shown in FIG. 3.

As shown in FIG. 3, the calibration system may determine one or more conditions of machine 10 for which recalibration is to occur (Step 210). For example, the identified condition may include required stopping distance, acceleration performance, or steering performance of machine 10. This identification may be made by either or both of controller 20 or an automated worksite management system, such as Caterpillar Inc.'s MINESTAR SYSTEM™. Recalibration of the vehicle model may be based on one or more of the following: when a time interval above a threshold number of days has elapsed since an initial or a previous calibration of the vehicle model; when machine 10 has operated for more than a threshold number of days since an initial or a previous calibration of the vehicle model; when machine 10 has traveled more than a threshold distance since an initial or a previous calibration of the vehicle model; and/or when the engine of machine 10 has operated for more than a threshold number of hours since an initial or a previous calibration of the vehicle model.

Alternately or additionally, recalibration of the vehicle model may be based on one or more of the following: when one or more components of machine 10 are adjusted, calibrated, repaired, replaced, or otherwise serviced (for example, drive components such as the engine, steering cylinder, brakes, suspension, tires, etc.; body components such as the dump bed, axle housing, etc.; or any other component of machine 10); when machine 10 has experienced an acceleration (such as a vertical acceleration) greater than a threshold amount (for example, as a result of machine 10 hitting a large bump, rock, or other obstruction on the worksite; as a result of machine 10 sliding on the worksite, etc.); when machine 10 has carried a load above a threshold weight (e.g., such as when machine 10 has been erroneously overloaded); when one or more components, fluids, or parts of machine 10 experience an amount of wear or degradation above a threshold amount, as determined by either or both of sensor readings or manual inspection; when an age of one or more components, fluids, or parts of machine 10 is above a threshold age; when one or more of computer software, computer hardware, or sensors are updated, reprogrammed, adjusted, calibrated, repaired, replaced, or otherwise serviced on machine 10; and/or when an aberration in the operation of any component of machine 10 is noted (either during normal operation of machine 10 or during a test event occurring in machine 10).

In accordance with any of the above-identified circumstances, data or other information may be collected by, provided to, analyzed by, and/or otherwise processed by one or both of controller 20 or the worksite management system. For example, controller 20 and/or the worksite management system may then determine that the required stopping distance for machine 10 is to be recalibrated in view of detected wear of drive components beyond a threshold amount.

As shown in FIG. 3, the calibration system may determine recalibration time information for the condition (Step 220). The time information may include when recalibration is to begin. For example, the time information may indicate that recalibration is to begin immediately (i.e., before machine 10 completes any further work on the autonomous worksite) when recalibration is for a critical or safety-related condition of machine 10. Alternately, for other conditions, the time information may indicate that recalibration is to occur when machine 10 is not otherwise working on the worksite.

The time information may also identify a time by which recalibration is to be completed. For example, for non-critical and non-safety-related conditions of machine 10, the time information may not require recalibration to begin immediately. But, the time information may indicate that recalibration is to be completed within the next fifty (50) hours of engine operation time, for example. The time information may also identify a consequence of the failure to timely complete recalibration. For example, machine 10 may be required to complete recalibration immediately before machine 10 performs any additional work on the worksite.

Alternately or additionally, the time information may indicate that recalibration may only occur during certain environmental conditions on the worksite. Examples of such environmental conditions include dry conditions, wet conditions, or icy conditions.

The calibration system may determine recalibration location information (Step 230). The location information may include a determination of which type of location is suitable for recalibration of the particular condition. For example, depending on the specific condition, recalibration may be accomplished on one or more of a mine road, a loading site, an unloading site, a dump site, or a bench site. Identification of the location information may also include a determination of whether a suitable area currently exists on the autonomous worksite. When the calibration system determines that a suitable area does not already exist on the worksite, the calibration system may specify that a particular calibration area is to be constructed on the worksite. This may be accomplished, for example, by either controller 20 or the worksite management system directing autonomous and/or manually-controlled vehicles to create roads or other calibration areas, with specific geometries or other specified characteristics, on the worksite.

The calibration system may determine recalibration testing condition information (Step 240). In particular, the calibration system may determine which testing condition or conditions are to be maintained as constant, and which testing condition or conditions are to be varied, so that recalibration may occur. For example, the calibration system may have determined, in Step 210, that the portion of the previously-calibrated vehicle model related to the required stopping distance of machine 10 is to be recalibrated. The calibration system may then determine, in Step 240, the particular weight and the particular load distribution machine 10 is to haul during recalibration. The calibration system may also determine that machine 10 is to proceed relatively straight (i.e., at a steering angle of about 0 degrees), on a relatively flat surface (i.e., such that the roll and pitch of the machine are each about 0 degrees) during recalibration, and that these testing conditions are not to be varied during recalibration. The calibration system may further determine the various, different speeds (i.e., variable testing conditions) at which machine 10 is to be recalibrated (e.g., 1 mile per hour, 3 miles per hour, 5 miles per hour, and 7 miles per hour).

Thus, in accordance with the above discussion the calibration system may determine a recalibration plan for machine 10. Implementation of the recalibration plan may be accomplished in a manner similar to that discussed above regarding the initial calibration of the vehicle model. For example, for the condition identified in Step 210 (e.g., the required stopping distance), and within the time period identified in Step 220 (e.g., within the next 50 engine hours), machine 10 may be moved to the location identified in Step 230 (e.g., a loading area on the worksite). The previously-calibrated vehicle model may be used to predict the operation of machine 10 under the test conditions identified in Step 240 (e.g., varying speeds, and constant steering angle, load weight, load distribution, etc., at which machine 10 is to be operated), and the actual operation of machine 10 under those conditions may be compared to the predictions. As long as a difference between the predicted and actual operation of machine 10 exceeds a threshold amount, the vehicle model may continue to be recalibrated. When the difference between the predicted and actual operations of machine 10 is within the threshold amount, the vehicle model may be considered recalibrated with respect to the particular condition identified in Step 210.

Thus, use of the disclosed calibration system to initially calibrate and subsequently recalibrate the vehicle model may provide numerous advantages. As discussed above, because calibration and recalibration occur on the autonomous worksite, delays associated with adjustment of the vehicle model on a specialized testing facility may be avoided. Further, the vehicle model of machine 10 may be more accurately calibrated and recalibrated as compared to known calibration processes, since machine 10 may be calibrated using actual conditions on the autonomous worksite.

Machine 10 may also store multiple vehicle models in the memory corresponding to different environmental conditions, and the multiple vehicle models may be calibrated during the corresponding environmental conditions. For example, machine 10 may store different vehicle models for dry conditions, icy conditions, and wet conditions. When the environmental conditions change on the autonomous worksite, the appropriate vehicle model may be calibrated and used to control machine 10.

Machine 10 may also store multiple vehicle models in the memory corresponding to different machine kinematics and/or dynamics, and the multiple vehicle models may be calibrated during operation. For example, machine 10 may store different vehicle models for articulated steering, Ackermann steering, front and/or rear wheel steering, and/or skid steering dynamics. During operation on the autonomous worksite, the appropriate vehicle model may be selected based on which calibrated vehicle model most closely predicts vehicle operation, and the selected vehicle model may be used to control machine 10.

It will be apparent to those skilled in the art that various modifications and variations can be made to the vehicle model calibration processes of the present disclosure. Other embodiments of the described methods and systems will be apparent to those skilled in the art from consideration of the specification and practice of the vehicle model calibration processes disclosed herein. It is intended that the specification and examples be considered as exemplary only, with a true scope of the disclosure being indicated by the following claims and their equivalents.

What is claimed is:

1. A method of recalibrating a vehicle model used to autonomously control a machine on a worksite, with a calibration system including at least one processor, the method comprising:
determining at least one recalibration condition for which recalibration of the vehicle model is to occur;
determining time information for the at least one recalibration condition, the time information including a determination of a time when recalibration is to be performed;
determining location information for the at least one recalibration condition, the location information including a determination of a location suitable for performing the recalibration; and
determining testing condition information for the at least one recalibration condition, the testing condition information including a determination of a testing condition to be used during the recalibration.

2. The method according to claim 1, wherein determining the at least one recalibration condition includes detecting an acceleration of the machine above a threshold amount, and determining the at least one calibration condition based on the detected acceleration.

3. The method according to claim 1, wherein determining the at least one recalibration condition includes detecting wear of the machine above a threshold amount, and determining the at least one recalibration condition based on the detected wear.

4. The method according to claim 3, where the wear of the machine is detected by a sensor on the machine.

5. The method according to claim 3, wherein the wear of the machine is detected by manual inspection of the machine.

6. The method according to claim 1, wherein determining the time information further includes determining a consequence of not completing the recalibration during a specified time period.

7. The method according to claim 1, wherein determining the location information further includes determining whether the location suitable for performing the recalibration exists on the worksite.

8. The method according to claim 7, wherein determining the location information further includes directing another vehicle to create the location suitable for performing the recalibration.

9. The method according to claim 1, wherein determining the testing condition information includes determining at least one testing condition of the machine that is to remain constant and determining at least one testing condition of the machine that is to be varied during the recalibration.

10. The method according to claim 1, wherein determining the at least one recalibration condition includes determining the at least one recalibration condition with a worksite management system or a controller on the machine.

11. A method of calibrating a vehicle model used to autonomously control a machine on a worksite, with a calibration system including at least one processor, the method comprising:
performing an initial calibration of the vehicle model by:
autonomously controlling a machine, based on the vehicle model, to perform an operation at a worksite;
during performance of the operation, determining at least one condition for which the vehicle model is to be calibrated;
determining machine performance of the operation during the at least one condition; and
adjusting the vehicle model based on the determined machine performance; and
recalibrating the vehicle model subsequent to the initial calibration by:
determining at least one recalibration condition for which recalibration of the vehicle model is to occur;
determining time information for the at least one recalibration condition, the time information including a determination of a time when recalibration is to be performed;
determining location information for the at least one recalibration condition, the location information including a determination of a location suitable for performing the recalibration;
determining testing condition information for the at least one recalibration condition, the testing condition information including a determination of a testing condition to be used during the recalibration; and
adjusting the initially-calibrated vehicle model for the recalibration condition based on the time information, the location information, and the testing condition information.

12. The method according to claim 11, wherein determining the at least one recalibration condition includes detecting an acceleration of the machine above a threshold amount, and determining the at least one calibration condition based on the detected acceleration.

13. The method according to claim 11, wherein determining the at least one recalibration condition includes detecting wear of the machine above a threshold amount, and determining the at least one recalibration condition based on the detected wear.

14. The method according to claim 13, where the wear of the machine is detected by a sensor on the machine.

15. The method according to claim 13, wherein the wear of the machine is detected by manual inspection of the machine.

16. The method according to claim 11, wherein determining the time information further includes determining a consequence of not completing the recalibration during a specified time period.

17. The method according to claim 11, wherein determining the location information further includes determining whether the location suitable for performing the recalibration exists on the worksite.

18. The method according to claim 17, wherein determining the location information further includes directing another vehicle to create the location suitable for performing the recalibration.

19. The method according to claim 11, wherein determining the testing condition information includes determining at least one testing condition of the machine that is to remain constant and determining at least one testing condition of the machine that is to be varied during the recalibration.

20. The method according to claim 11, wherein determining the at least one recalibration condition includes determining the at least one recalibration condition with a worksite management system or a controller on the machine.
